(19) United States
(12) Patent Application Publication
(10) Pub. No.: US 2015/0019084 A1
(43) Pub. Date: Jan. 15, 2015

(54) METHOD, SYSTEM, AND VEHICLE WITH CONTROLLED DOOR OPENING

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: WEN-HUA CHEN, Shenzhen (CN); XIN GUO, Shenzhen (CN)

(21) Appl. No.: 14/325,915

(22) Filed: Jul. 8, 2014

(30) Foreign Application Priority Data
Jul. 15, 2013 (CN) 2013102941984

(51) Int. Cl. E05F 15/20

(52) U.S. Cl. CPC E05F 15/2023; E05F 2015/2069
USPC 701/49

(57) ABSTRACT

In a door opening control method executed in a vehicle, an association between a ratio of a size of a moving object in an image to a size of the image and a distance between the moving object and the vehicle is established. A first image and a second image of the moving object are captured at a first time and a second time respectively. A first ratio and a second ratio are calculated, and a first distance and a second distance are determined. A velocity and an approach time of the moving object are calculated and if the approach time is greater than a predetermined time, a door of the vehicle is permitted to be opened by a passenger request, otherwise the passenger request is refused.

### CROSS-REFERENCE TO RELATED APPLICATIONS

This application claims priority to Chinese Patent Application No. 201310294198.4 filed on Jul. 15, 2013 in the China Intellectual Property Office, the contents of which are incorporated by reference herein.

### FIELD

The subject matter herein generally relates to transportation safety.

### BACKGROUND

Passengers in a vehicle may not be mindful of road dangers. When an object (e.g., another vehicle) is moving toward the vehicle, and a passenger opens a door of the vehicle, an accident may occur. Therefore, there is a safety need for door opening control.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a door opening control system.

FIG. 2 is a block diagram of one example embodiment of function modules of the door opening control system in FIG. 1.

FIG. 3 is a flowchart of one example embodiment of a door opening control method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

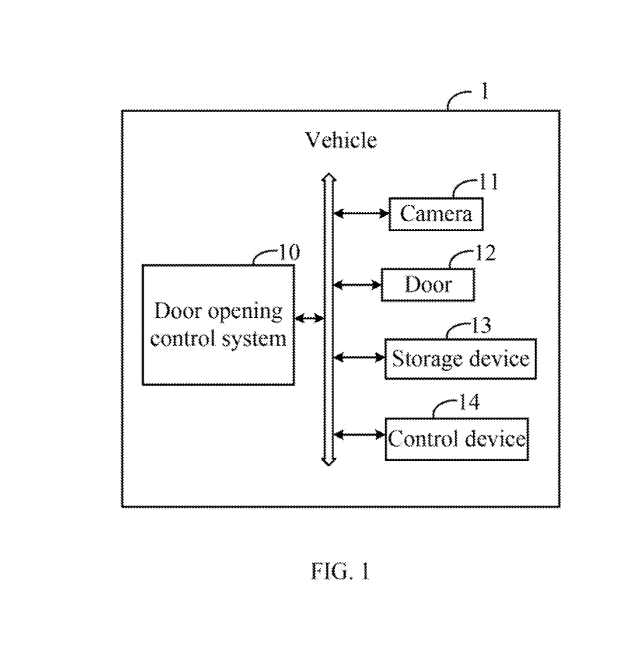

FIG. 1 is a block diagram of one example embodiment of a hardware environment for executing a door opening control system 10. The door opening control system 10 is installed and ran in a vehicle 1. The vehicle 1 can include a camera 11, at least one door 12, a storage device 13, and at least one control device 14.

The camera 11 captures images of moving objects around the vehicle 1. In this embodiment, the camera 11 is installed in a tail section of the vehicle 1 to capture images of moving objects behind the vehicle 1. Depending on the embodiment, the camera 11 can be installed in other parts of the vehicle 1. For example, the camera 11 can be installed in a front section of the vehicle 1 to capture images of moving objects in front of the vehicle 1. The moving objects can be other vehicles, for example.

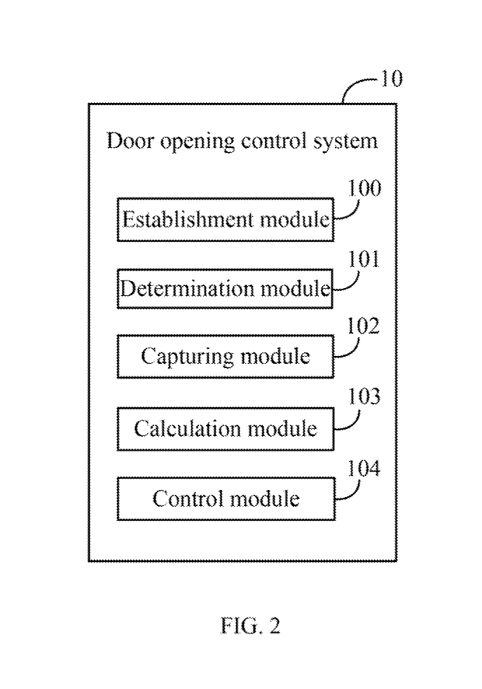

The door opening control system 10 can include a plurality of function modules (shown in FIG. 2) that calculate an approach time that might be taken by a moving object toward the vehicle 1, and control the door 12 according to the approach time.

The storage device 13 can include some type(s) of non-transitory computer-readable storage medium such as, for example, a hard disk drive, a compact disc, a digital video disc, or a tape drive. The storage device 13 stores the computerized codes of the function modules of the door opening control system 10.

The control device 14 can be a processor, an application-specific integrated circuit (ASIC), or a field programmable gate array (FPGA), for example. The control device 14 can execute computerized codes of the function modules of the door opening control system 10 to realize the functions of the vehicle 1.

FIG. 2 is a block diagram of one embodiment of function modules of the door opening control system 10. The function modules can include an establishment module 100, a determination module 101, a capturing module 102, a calculation module 103, and a control module 104. The function modules 100-104 can include computerized codes in the form of one or more programs, which provide at least the functions of the door opening control system 10.

The establishment module 100 establishes an association between a ratio of a size of a moving object in an image to a size of the image and a distance between the moving object and the vehicle 1, and stores the association into the storage device 13.

In response to a passenger command to open a door 12 of the vehicle 1, the determination module 101 determines whether the vehicle 1 has stopped. If the vehicle 1 has not stopped, the determination module 101 does not permit the door 12 to be opened.

If the vehicle 1 has stopped, the capturing module 102 controls the camera 11 to capture a first image and a second image of the moving object at a first time and a second time respectively. The capturing module 102 calculates a first ratio of a size of the moving object in the first image to a size of the first image, and determines a first distance between the moving object and the vehicle 1 corresponding to the first ratio according to the association. Similarly, the capturing module 102 calculates a second ratio of a size of the moving object in the second image to a size of the second image, and determines a second distance between the moving object and the vehicle 1 corresponding to the second ratio according to the association.

The calculation module 103 calculates a velocity of the moving object according to the first distance, the second distance, the first time, and the second time, and calculates an approach time that will be taken by the moving object to move to the vehicle 1 according to the second distance and the velocity of the moving object.

The control module 104 determines whether the approach time is greater than a predetermined time (for example, 2 seconds). If the approach time is greater than the predetermined time, the control module 104 permits the door 12 to be opened. Otherwise, if the approach time is not greater than the predetermined time, the control module 104 sends out an alarm via a warning device (for example, a buzzer or a light) and does not permit the door 12 to be opened.

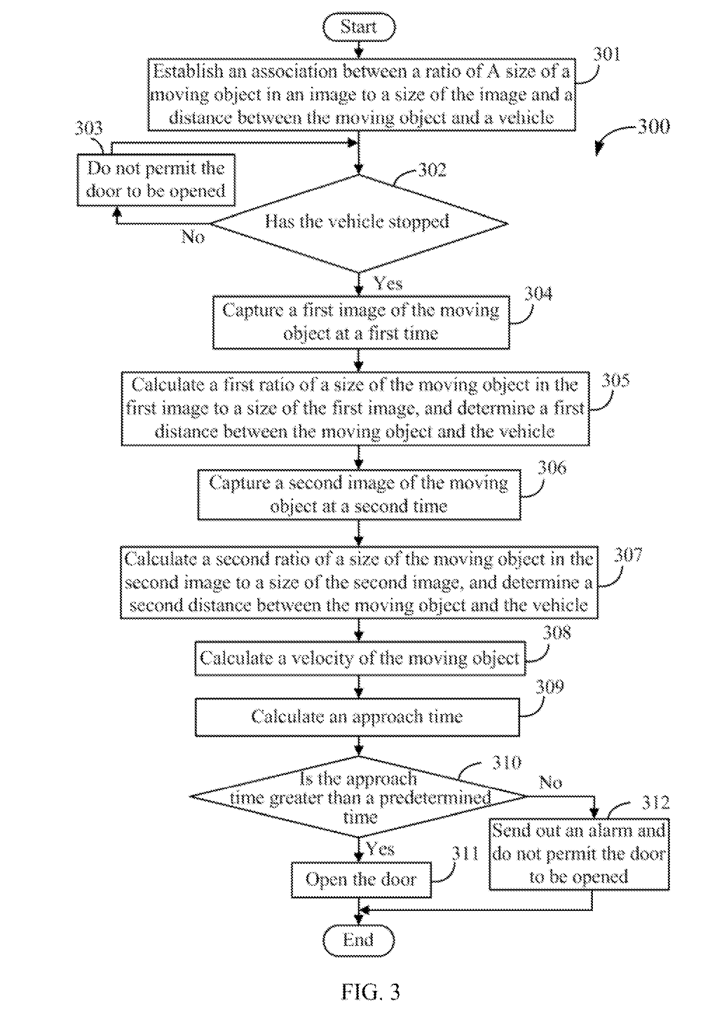

FIG. 3 is a flowchart of one example embodiment of a door opening control method. In the embodiment, the method is performed by execution of computer-readable software program codes or instructions by the control device 14, such as at least one processor of the vehicle 1.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1 and 2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, an establishment module establishes an association between a ratio of a size of a moving object in an image to a size of the image and a distance between the moving object and the vehicle 1, and stores the association into the storage device 13. According to the association, a distance between the moving object and the vehicle 1 corresponding to a given ratio of the size of the moving object in the image to the size of the image is determined. The larger the ratio of the size of the moving object in the image to the size of the image, the shorter the distance determined between the moving object and the vehicle 1. For example, if the ratio of the size of the moving object in the image to the size of the image is 5 percent, the distance between the moving object and the vehicle 1 is 100 meters. If the ratio of the size of the moving object in the image to the size of the image is 10 percent, the distance between the moving object and the vehicle 1 is 80 meters.

In response to a passenger command to open a door 12 of the vehicle 1, at block 302, a determination module determines whether the vehicle 1 has stopped.

If the vehicle 1 has not stopped, at block 303, the determination module does not permit the door 12 to be opened, and the flow returns to block 302.

If the vehicle 1 has stopped, at block 304, a capturing module controls the camera 11 to capture a first image of the moving object at a first time.

At block 305, the capturing module calculates a first ratio of a size of the moving object in the first image to a size of the first image, and determines a first distance between the moving object and the vehicle 1 corresponding to the first ratio according to the association. For example, the first ratio of the size of the moving object in the first image to the size of the first image is 5 percent. The capturing module thus determines that the first distance between the moving object and the vehicle 1 is 100 meters.

At block 306, the capturing module controls the camera 11 to capture a second image of the moving object at a second time. The second time is at a later time from the first time.

At block 307, the capturing module calculates a second ratio of a size of the moving object in the second image to a size of the second image, and determines a second distance between the moving object and the vehicle 1 corresponding to the second ratio according to the association. For example, the second ratio of the size of the moving object in the second image to the size of the second image is 10 percent. The capturing module determines that the second distance between the moving object and the vehicle 1 is 80 meters.

At block 308, a calculation module calculates a velocity of the moving object according to the first distance, the second distance, the first time, and the second time. In one embodiment, the velocity of the moving object (denoted as “v”) can be calculated as follows: v=|s1−s2|/|t1−t2|, where “s1” is the first distance, “s2” is the second distance, “t1” is the first time, and “t2” is the second time.

At block 309, the calculation module calculates an approach time that will be taken by the moving object to move to the vehicle 1 according to the second distance and the velocity of the moving object. In one embodiment, the approach time (denoted as “t”) can be calculated as follows: t=s2/v, where “s2” is the second distance and “v” is the velocity of the moving object.

At block 310, a control module determines whether the approach time is greater than a predetermined time, such as 2 seconds, for example.

If the approach time is greater than the predetermined time, at block 311, the control module permits the door 12 to be opened.

Otherwise, if the approach time is not greater than the predetermined time, at block 312, the control module sends out an alarm via a warning device (for example, a buzzer or a light) and does not permit the door 12 to be opened.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A door opening control method being executed by at least one control device of a vehicle, the method comprising:
establishing an association between a ratio of a size of a moving object in an image to a size of the image and a distance between the moving object and the vehicle;
in response to a passenger command to open a door of the vehicle, controlling a camera installed on the vehicle to capture a first image of the moving object at a first time, calculating a first ratio of a size of the moving object in the first image to a size of the first image, determining a first distance between the moving object and the vehicle corresponding to the first ratio according to the association, controlling the camera to capture a second image of the moving object at a second time, calculating a second ratio of a size of the moving object in the second image to a size of the second image, and determining a second distance between the moving object and the vehicle corresponding to the second ratio according to the association, wherein the second time is at a later time from the first time;
calculating a velocity of the moving object according to the first distance, the second distance, the first time, and the second time, and calculating an approach time that will be taken by the moving object to move to the vehicle according to the second distance and the velocity of the moving object; and
permitting the door to be opened when the approach time is greater than a predetermined time.

2. The method according to claim 1, further comprising:
sending out an alarm and not permitting the door to be opened when the approach time is not greater than the predetermined time.

3. The method according to claim 1, further comprising:
not permitting the door to be opened when the vehicle has not stopped.

4. A vehicle comprising:
a control device; and
a storage device storing one or more programs which when executed by the control device, causes the control device to perform operations comprising:
establishing an association between a ratio of a size of a moving object in an image to a size of the image and a distance between the moving object and the vehicle;
in response to a passenger command to open a door of the vehicle, controlling a camera installed on the vehicle to capture a first image of the moving object at a first time, calculating a first ratio of a size of the moving object in the first image to a size of the first image, determining a first distance between the moving object and the vehicle corresponding to the first ratio according to the association, controlling the camera to capture a second image of the moving object at a second time, calculating a second ratio of a size of the moving object in the second image to a size of the second image, and determining a second distance between the moving object and the vehicle corresponding to the second ratio according to the association, wherein the second time is at a later time from the first time;
calculating a velocity of the moving object according to the first distance, the second distance, the first time, and the second time, and calculating an approach time that will be taken by the moving object to move to the vehicle according to the second distance and the velocity of the moving object; and
permitting the door to be opened when the approach time is greater than a predetermined time.

5. The vehicle according to claim 4, wherein the operations further comprise:
sending out an alarm and not permitting the door to be opened when the approach time is not greater than the predetermined time.

6. The vehicle according to claim 4, wherein the operations further comprise:
not permitting the door to be opened when the vehicle has not stopped.

7. A non-transitory storage medium having stored thereon instructions that, when executed by a control device of a vehicle, causes the control device to perform a door opening control method, the method comprising:
establishing an association between a ratio of a size of a moving object in an image to a size of the image and a distance between the moving object and the vehicle;
in response to a passenger command to open a door of the vehicle, controlling a camera installed on the vehicle to capture a first image of the moving object at a first time, calculating a first ratio of a size of the moving object in the first image to a size of the first image, determining a first distance between the moving object and the vehicle corresponding to the first ratio according to the association, controlling the camera to capture a second image of the moving object at a second time, calculating a second ratio of a size of the moving object in the second image to a size of the second image, and determining a second distance between the moving object and the vehicle corresponding to the second ratio according to the association, wherein the second time is at a later time from the first time;
calculating a velocity of the moving object according to the first distance, the second distance, the first time, and the second time, and calculating an approach time that will be taken by the moving object to move to the vehicle according to the second distance and the velocity of the moving object; and
permitting the door to be opened when the approach time is greater than a predetermined time.

8. The non-transitory storage medium according to claim 7, wherein the method further comprises:
sending out an alarm and not permitting the door to be opened when the approach time is not greater than the predetermined time.

9. The non-transitory storage medium according to claim 7, wherein the method further comprises:
not permitting the door to be opened when the vehicle has not stopped.
